(19) United States
(12) Patent Application Publication
(10) Pub. No.: US 2010/0050402 A1
(43) Pub. Date: Mar. 4, 2010

(54) LOCKING DEVICE

(75) Inventor: Ian Rissman, Helensvale (AU)

Correspondence Address: LAW OFFICE OF DELIO & PETERSON, LLC., 121 WHITNEY AVENUE, 3RD FLLOR, NEW HAVEN, CT, 06510, US

(73) Assignee: WORISSFIELD PTY LTD., Northgate (AU)

(21) Appl. No.: 12/617,014

(22) Filed: Nov. 12, 2009

Related U.S. Application Data
(63) Continuation-in-part of application No. PCT/AU2008/000668, filed on May 3, 2008.

(30) Foreign Application Priority Data
May 15, 2007 (AU) AU2007902573

(51) Int. Cl. A44B 99/00; B23P 11/00

(52) U.S. Cl. 24/645; 29/525.03

(57) ABSTRACT

A locking device for use in securing a first part relative to a second part.

### BACKGROUND OF THE INVENTION

1. Field of the Invention

The present invention generally relates to a locking device for use in securing a first part relative to a second part.

2. Description of Related Art

In heavy industrial excavating equipment such as buckets used on draglines, loaders including front-end loaders, dippers, backhoes, shovels and other such large earthmoving machines, it is a common problem that the metal teeth on the leading edge(s) of the bucket become worn as the bucket is repeatedly forced through the ground during use. This wear can eventually render the teeth ineffectual requiring the teeth, or at least the point or tip of each worn tooth, to be replaced. Consequently, a number of assemblies have been developed where each tooth, or at least the point or tip thereof, can be replaced. For convenience, the prominent end or part of each excavator tooth that wears down during use and which can be replaced (typically the point or tip thereof) will be referred to generically as the “tooth point member”.

Excavator tooth assemblies of the kind where each replaceable tooth point member is mounted on an adapter are quite widely used. In these assemblies, the tooth point member is generally mounted on the front of the adapter so that the tooth point member protrudes forwardly from the leading edge of the excavator bucket or other piece of excavating equipment. To facilitate this mounting, each adapter typically has a forward pointing nose portion and each tooth point member typically has a hollow rear end which is adapted to slot over and be received on the nose of the adapter. The adapter and the tooth point member each also typically have an aperture therein. The respective apertures are arranged so that when the tooth point member is received in position on the nose of the adapter, the aperture in the tooth point member comes into register (i.e. coaxial alignment) with the aperture in the nose. A retaining pin or some other device or mechanism can then be positioned in the registered (i.e. coaxially aligned) apertures to thereby secure the tooth point member to the adapter. The pin or other device can also be removed to allow a worn tooth point member to be removed and replaced.

In early assemblies of the kind described above, the apertures in the adapter and the tooth point member were oriented vertically in use (perpendicular to the horizontal leading edge of the bucket) and a retaining pin would be driven (using a hammer) into the registered apertures to secure the tooth point member to the adapter. One problem with these early assemblies was that, because the apertures were oriented vertically when the excavating equipment was in use, there was a danger that the pin could fall out allowing the tooth point member to fall off the adapter. Some alternative designs were then proposed with the apertures in the adapter and the tooth point member oriented horizontally in use (parallel to the horizontal leading edge of the bucket). This overcame the risk of the pin falling out. However, the assemblies where the apertures were oriented horizontally when the excavating equipment was in use were largely rejected by industry due to the difficulty in accessing the apertures. It will be appreciated that multiple tooth point members are generally disposed in a close side-by-side configuration on the leading edge of the bucket, leaving limited room in between them. Therefore, even though the amount of room between the tooth point members may have been enough for the pin to fit in between, the limited amount of room typically made it very difficult to swing a hammer to drive the pin in or out.

Australian Patent Number 659305 to Matthews describes an arrangement in which the apertures in the adapter and the tooth point member are arranged vertically in use (meaning that the mechanism for locking the tooth point member to the adapter is easily accessible), and which also substantially ameliorates the problem of the retaining pin falling out. The arrangement in U.S. Pat. No. 659,305 has two components, namely a holding member and a locking member, which are inserted in a particular way into the registered apertures to lock the tooth point member to the adapter. The holding member comprises a generally elongate block-shaped rigid metal component with a protruding shoulder on each end. Therefore, the holding member appears to be shaped roughly like a square bracket (i.e. like “[”) when viewed side on. The locking member is also generally block-shaped and made from rigid metal, but it has a pair of small rounded metal lugs positioned approximately halfway down its long side edges. It therefore has a generally “ [symbol] ” shape when viewed front on.

The way the holding member and the locking member in U.S. Pat. No. 659,305 are used to secure the tooth point member to the adapter may be described as follows. First, the tooth point member is positioned on the nose of the adapter so that the aperture in the tooth point member comes into register with the aperture in the adapter. The holding member can then be inserted axially into the registered apertures. After being inserted, the holding member can then be moved slightly laterally so that the insides of its shoulders engage with corresponding edges on the adapter. This engagement prevents the holding member from moving axially back out of the registered apertures. The locking member is then used to lock the holding member in place (i.e. to prevent it from moving laterally back out of engagement with the edges on the adapter). This is done by inserting the locking member axially into the registered apertures as well so that the locking member occupies the remaining space in the apertures (i.e. the remaining space between the flat back face of the “[” shaped holding member and the inside of the registered apertures).

Consequently, with the arrangement in U.S. Pat. No. 659,305, the only way the holding member can fall out of the apertures is if it is allowed to move laterally back so that its shoulders disengage from the edges on the adapter. However, the presence of the locking member prevents this from happening. The way the locking member occupies the remaining space in the apertures also helps to prevent the tooth point member from rattling around on the end of the adapter when it is secured in place.

The purpose of the lugs on the side edges of the locking member in U.S. Pat. No. 659,305 is to secure the locking member in position and prevent it from falling out. A pair of corresponding notches are provided inside the adapter, and the lugs on the locking member engage in these notches when the locking member is inserted. However, except at the notches, the apertures in the tooth point member and the adapter are slightly narrower than the width between the tips of the locking member's two lugs. Therefore, in order to insert the locking member into the registered apertures it is necessary to use a hammer to drive the locking member into the apertures until the lugs on the side of the locking member lock into place in the notches in the adapter.

With the arrangement in U.S. Pat. No. 659,305, when it is necessary to replace a worn tooth point member, a hammer must again be used to drive (or punch) the locking member axially back out of the registered apertures. With the locking member removed, the holding member is then able to be moved back laterally so that its shoulders disengage from the edges on the adapter thereby allowing the holding member to be removed as well. The worn tooth point member can then be replaced with a new tooth point member and locked in place by repeating the process described above.

The arrangement described in U.S. Pat. No. 659,305 is considered to operate very well to secure the tooth point member to the adapter. However, the need to use a hammer to insert and remove the locking member creates a significant workplace health and safety risk. For example, there is a danger that a person's body part may be struck and seriously injured as a hammer is used to drive the locking member in and out. Similarly, the act of wielding the hammer also has inherent potential to cause injury, such as back, shoulder or other muscle or joint injuries. Workplace health and safety standards are therefore increasingly requiring the use of systems or devices which eliminate the need to use hammers and other such heavy striking tools. It is an object of the present invention to provide a locking device that may at least partially overcome the above-mentioned problem, or which may provide a useful or commercial alternative in the marketplace.

It will be clearly understood that mere reference herein to previous excavator tooth assemblies or other background material (including publications) does not constitute an acknowledgement or admission that any excavator tooth assembly or other material(s) of whatever kind, or any combination thereof, formed part of the common general knowledge in the field or is/are otherwise admissible prior art, whether in Australia or any other country.

### SUMMARY OF THE INVENTION

In a first broad form, the present invention resides in a locking device for use in securing a first part relative to a second part, the locking device having a body, one or more locking portions which can be extended to protrude outwardly relative to the body and also retracted inwardly relative to the body, biasing means for biasing said locking portions to retract into the body, and means for selectively extending and retracting the one or more locking portions. In a slightly more specific aspect, this form of the invention resides in a locking device for use in securing an excavator tooth point member to an adapter, the locking device having a body, one or more locking portions which can be extended to protrude outwardly relative to the body and also retracted inwardly relative to the body, and means for selectively extending and retracting the one or more locking portions.

The way the locking portion(s) of the device can be selectively extended and retracted may at least help to overcome the need for hammers as described above. Indeed, when inserting the locking device of the present invention, the locking portion(s) (or possibly just one or some of the locking members if there are more than one) can be retracted so that the device can be easily inserted, generally by hand. This may be contrasted with prior arrangements such as the locking member in U.S. Pat. No. 659,305 in which the width between the lugs on the locking member impeded its insertion/retraction and therefore required a hammer to drive it in/out. Once the device of the present invention is inserted, it may be operated to extend the previously retracted locking portion(s) thereby securing the device in position. Conversely, when it is desired to replace a worn tooth point member, the device can be operated to retract the locking portion(s) allowing the device to be easily removed or slid back out, again, generally by hand. The worn tooth point member can then be removed and replaced.

Another possible benefit of the present invention may be that, because it may no longer be necessary to use hammers to drive a retaining pin or similar component into the apertures to secure the tooth point member to the adaptor, it may again be possible for the apertures in the adapter and the tooth point member to be oriented horizontally in use. This is because, at least with some possible embodiments of the invention, the amount of room needed to operate the extending and retracting means may be considerably less than the amount of room required to swing a hammer to drive the prior art retaining pins etc into the apertures. Therefore, with these embodiments, the amount of room between the teeth may be sufficient to allow easy insertion, retraction and operation of the locking device. Horizontal apertures may have the benefit of further reducing the risk of the locking device falling out, for example in the unlikely event of the locking device becoming damaged and not functioning properly.

Those skilled in this area will understand that when transverse load is applied to a solid body, this can impose a bending moment which can in turn causes compressive stresses in some parts of the body and tensile stresses in other parts of the body. There is therefore a transition between portions of the body under tensile stress and portions of the body under compressive stress. This transition is represented as a line extending across a cross-section of the body, and this line is commonly referred to as the “neutral axis”.

Where the apertures in the adapter and the tooth point member are oriented horizontally, the apertures may be positioned such that the locking device is inserted along the neutral axis of the cross-section of the joined adapter+tooth point member (i.e. the cross-section taken through the adapter and tooth point member when the two are joined together). This may help to minimise the compressive and tensile stresses imposed on the locking device.

However, it will be clearly understood to using horizontal apertures is by no means necessary to the present invention, and in fact it is envisaged that the invention will be used mostly with adapters and tooth point members having apertures that are oriented vertically in use. Therefore, it is envisaged that the locking device of the present invention will typically be used with adapters and tooth point members that operate in generally the same way as those shown and described in U.S. Pat. No. 659,305.

The locking device of the present invention will typically have a body. The body will generally comprise a casing for housing the internal working components of the device. It will preferably be made from metal or some other suitably robust material. In preferred embodiments, the body may be substantially block shaped. It may also be formed from two or more parts which can be assembled together to form the casing. The two or more parts may be securely connected together by screws, bolts, rivets, welding or any other kind of suitably strong fastener or joining means. The inside of the body may be shaped so as to support and interact with the working components of the device. In some embodiments of the invention, the casing may also have one or more openings therein to allow certain working components of the device to extend out from inside the body through the opening(s). The working components of the device are described further below.

The locking device of the present invention also has one or more locking portions which can be extended and retracted. As with the prior art excavator tooth arrangements, the tooth point member or the adapter, or both, will have some form of indent(s), recess(es), notch(es) or other feature(s) with which the device's locking portion(s) can engage to secure the tooth point member to the adapter when the locking device is inserted and the locking portion(s) are extended. In some preferred embodiments, the one or more locking portions may comprise one or more locking tabs. The locking tabs may be made from metal or some other similar the robust material. In particularly preferred embodiments where the body of the device is substantially block shaped, a pair of locking tabs may be provided which can be selectively extended out from inside the body through openings in the opposing long sides of the body. The tabs should also be retractable back into the body. However, those skilled in this area will clearly appreciated the locking portion(s) of the present invention may take a wide range of alternative forms other than the locking tabs just described. For example, in some other embodiments of the invention, one or more exterior parts of the body itself may be selectively extendable and retractable relative to the rest of the body to form the locking portion(s). Furthermore, it is possible that some versions of the present locking device may incorporate a combination of two or more different kinds of locking portions at once. In any event, it will be understood that all possible configurations of the locking portion(s) fall within the scope of the present invention.

In order for the locking device of the present invention to be operated, it incorporates means for selectively extending and retracting the one or more locking portions. Again, a wide range of operating means may be used for this purpose. In one example, the operating means may comprise a threaded rod mounted in a correspondingly threaded opening in a part of the body which is accessible even when the device is inserted into the registered apertures to secure the tooth point member to the adapter. One end of the rod may extend out through the opening to be proud of the body when the locking portion(s) are retracted. The protruding end of the rod may be adapted to be connected to and rotated by a range of tools. For example, the rod may have a conventional hexagonal bolt-head shape to enable it to be gripped and manipulated by a conventional tool such as a socket, spanner or drill-mounted socket. Alternatively, it may have an aperture in the end to allow it to be rotated using an Alan Key (hex wrench), screwdriver or the like. The threaded portion of the rod may extend through the threaded hole in the body and into the body. Hence, rotation of the rod in one direction may cause the rod to screw further into the body, whereas rotation of the rod in the other direction may cause the rod to unscrew and extend further out from the body.

In some embodiments of the invention, the end of the rod that is inside the body may engage with the internal working components of the device. In particularly preferred embodiments, the internal end of the rod may engage with one or more locking tabs of the kind described above. The locking tabs may be mounted within the body in a manner whereby they are biased towards the retracted position where they do not extend out from the body. Resilient rubber mounts may be used to bias the locking tabs, although alternative biasing mean such as springs may also be used. The end of the rod that is inside the body may be tapered so as to provide an angled surface that engages the one or more locking tabs forcing the locking tab(s) to extend progressively outwardly from the body as the rod is screwed into the body. Conversely, as the rod is unscrewed, the tabs may retract back into the body under the bias.

Whilst preferred embodiment of the invention may operate with a threaded rod that engages with one or more locking tabs as described above, the invention is not limited to this arrangement and a wide range of other operating means may also be used to selectively extend and retract the locking portion(s). For example, a variety of alternative mechanical arrangements using shackles, chains etc may be possible. It is also possible that the locking portion(s) may be selectively actuated between the retracted position and the extended position by pneumatic means. This might involve the device being pressurised when it is desired to extend the locking portion(s), the pressure forcing them out, and the device also being provided with a valve or something similar which can be operated to release the pressure allowing the locking portion(s) to retract. A range of other possibilities will also be evident to those skilled in this area.

Preferred embodiments of the locking device of the present invention will generally cooperate with a separate holding member to secure the tooth point member to the adapter. The holding member may be generally similar to the holding member described in U.S. Pat. No. 659,305 in that it may be a substantially rigid (preferably metal) component which is shaped so as to engage with the adapter or the tooth point member, or both, to prevent it from moving or sliding out after being inserted. However, no limitation whatsoever is meant in this regard, and some embodiments of the invention may operate to secure the tooth point member to the adapter without the need for a separate holding member.

Where a holding member is used, it may be provided with alignment means to help align the locking device with the holding member in use. The alignment means may comprise an elongate slot or keyway in the holding member, and the locking device may have a ridge adapted to fit into the slot/keyway to align the locking device with a holding member. A range of other alignment means may also be used.

In a second broad form, the invention resides in a mechanism for securing a first part relative to a second part, the mechanism comprising a holding member for engaging with a locking device, the holding member having at least one protruding or recessed portion which can engage with a recessed or protruding portion in one or both of the first part or the second part, and the locking device having a body, one or more locking portions which can be extended to protrude outwardly relative to the body and also retracted inwardly relative to the body, biasing means for biasing said locking portions to retract into the body and means for selectively extending and retracting the one or more locking portions.

In a third broad form the present invention resides in a method for securing a first part relative to a second part, the method involving:

assembling the first part and the second part together such that an aperture in the first part becomes registered with a corresponding aperture in the second part,

inserting a holding member into the registered apertures such that at least one protruding or recessed portion of the holding member engages with a recessed or protruding portion in one or both of the first part or the second part to prevent removal of the holding member from the apertures and

inserting a locking device into the apertures and then operating the locking device such that one or more locking portions act against biasing means and extend to engage with one or both of the second part or the first past to prevent removal of the locking device from the apertures.

In a more specific aspect of the third broad form, the invention resides in a method for securing an excavator tooth point member to an adapter, the method involving:

assembling the tooth point member and the adapted together such that an aperture in the tooth point member becomes registered with a corresponding aperture in the adapter,

inserting a holding member into the registered apertures such that at least one protruding or recessed portion of the holding member engages with a recessed or protruding portion in one or both of the tooth point member or the adapter to prevent removal of the holding member from the apertures and

inserting a locking device into the apertures and then operating the locking device such that one or more locking portions extend to engage with one or both of the adapter or the tooth point member to prevent removal of the locking device from the apertures.

### BRIEF DESCRIPTION OF THE DRAWINGS

Embodiments of the invention are described below with reference to the drawings. However, it will be clearly appreciated that the embodiments are described for the purposes of illustration only and the invention is not necessarily limited to or by the particular features described. In the drawings:

FIG. 1 shows an exploded perspective view of an excavator tooth assembly including an adapter, a tooth point member, and a locking mechanism in accordance with an embodiment of the invention presently described.

FIG. 2 shows a partial cross-sectional view through the assembled excavator tooth assembly of FIG. 1 with the locking mechanism inserted. In FIG. 2, a locking device in accordance with the embodiment has been inserted but has not yet been operated to extend the locking portions.

FIG. 3 shows a similar partial cross-sectional view to FIG. 2, except that the locking mechanism has been removed to show the features on the adapter and the tooth point member which interact with the holding member and the locking device.

FIG. 4a shows a perspective view of the holding member and the locking device together.

FIG. 4b shows the locking portions of the locking device in the extended position. In this figure, only the locking portions are visible because the rest of the locking device is hidden behind the holding member.

FIG. 4c is a similar view to FIG. 4b, except that the locking portions of the locking device are retracted. In this figure, the only part of the locking device that is visible is the rod which is unscrewed and extends out from the locking device when the locking portions a retracted. The rest of the locking device is hidden behind the holding member.

FIG. 5 shows the internal workings of the locking device.

FIG. 6 shows an industrial shackle assembly in accordance with another embodiment of the present invention.

FIG. 7 shows a sectional view of the shackle assembly of FIG. 6.

FIG. 8a shows an upper hoist assembly in accordance with another embodiment of the present invention.

FIG. 8b shows a sectional view of the upper hoist assembly of FIG. 8a.

FIG. 9a shows a rope socket assembly in accordance with another embodiment of the present invention.

FIG. 9b shows a sectional view of the rope socket assembly of FIG. 9a.

FIG. 10a shows a spreader bar assembly in accordance with another embodiment of the present invention.

FIG. 10b shows a sectional view of the spreader bar assembly of FIG. 10a.

### DESCRIPTION OF THE PREFERRED EMBODIMENT(S)

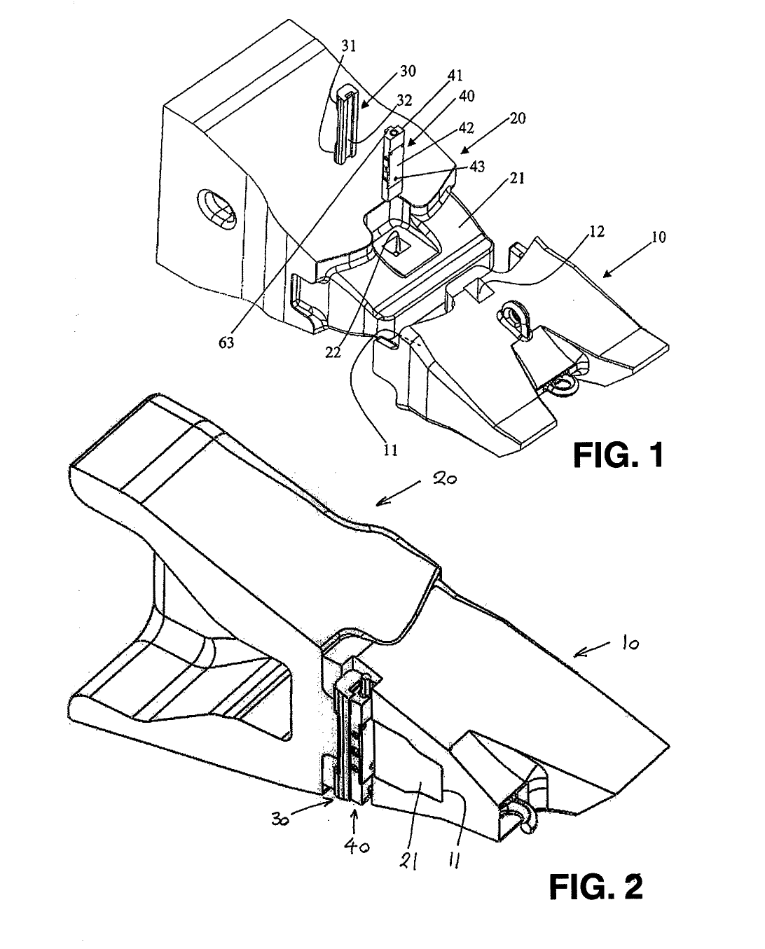

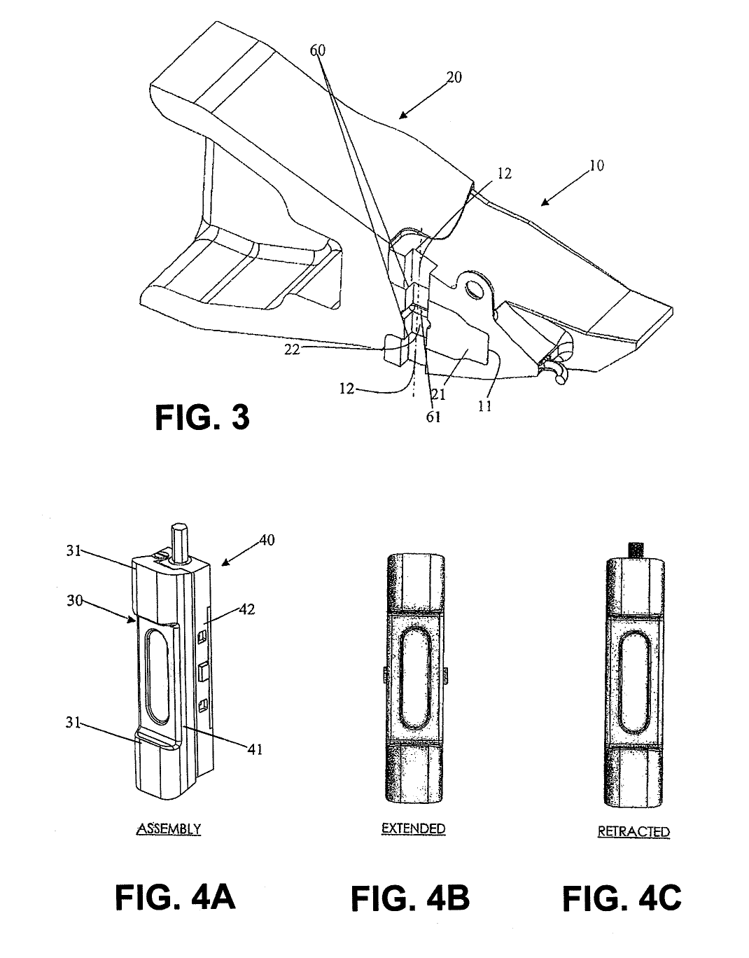

Referring first to FIGS. 1-3, it can be seen that the excavator tooth assembly comprises a tooth point member 10 (which will be referred to as the “tooth”) and an adapter 20. As shown in FIGS. 2 and 3, tooth 10 has a deep concave recess 11 defining a hollow rear end of the tooth. Adapter 20 has a forwardly protruding nose portion 21 whose shape corresponds to the internal shape of the recess 11 in the tooth. Hence, the tooth can be mounted on the adapter by sliding the hollow rear end of the tooth 10 onto the nose where it is snugly received as shown in FIGS. 2 and 3.

Also, from FIGS. 1-3 it can be seen that there is a square aperture 22 extending vertically through the full thickness of the nose 21 of the adapter. The tooth 10 also has a pair of corresponding square apertures 12 extending vertically through the thickness of the top and bottom walls of the tooth's hollowed out rear end. When the tooth 10 is slid onto the nose 21 of the adapter, the apertures 12 in the tooth come into alignment with the apertures 22 in the nose of the adapter. This is particularly clear from FIG. 3.

The mechanism used to secure tooth 10 in position on the nose 21 of the adapter comprises a holding member 30 and a locking device 40. The holding member is a generally elongate block-shaped rigid metal component with a protruding shoulder 31 at each end. Therefore, the holding member appears to be shaped roughly like a square bracket (i.e. like “[”) when viewed side on. FIG. 1 also shows that holding member 30 has an elongate slot 32 extending down the length of its otherwise substantially flat back face (i.e. down the face on the opposite side from the shoulders 31). The slot 32 helps to align the locking device 40 as described further below. The slot 32 also provides the holding member 30 with increased rigidity and slightly reduced weight.

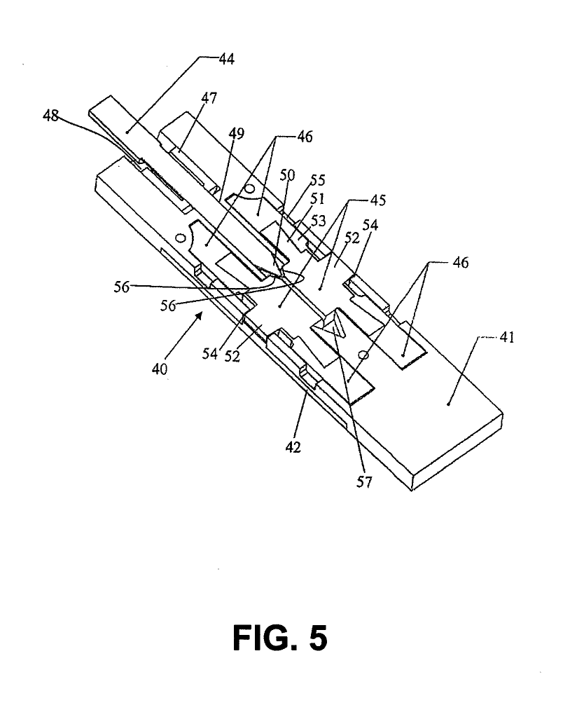

From FIG. 1 it can be seen that the locking device 40 is a generally block shaped component. The body of locking device 40 comprises a main casing 41 and a cover plate 42 which is secured by screws or rivets 43 to main casing 41 to conceal the internal workings of the device. The internal workings of the device are shown more clearly in FIG. 5.

From FIG. 5, it can be seen that main casing 41 has an internal cavity within which the internal working components of the locking device are assembled. The internal working components of the locking device include a threaded rod 44 (the “screw”), a pair of locks 45, and four bonded biasing rubbers 46. There is also an insert 47 inserted into a round open bore 48 in the top of casing 41. The end of the screw that is accessible from outside the casing 41 has a conventional hexagonal bolt-head shape to enable it to be rotated using tools such as sockets etc.

The four biasing rubbers 46 are bonded into the corners of the cavity in the main casing 41. The two locks 45 are positioned side-by-side within the cavity. Each lock 45 has a pair of wings 51, and each rubber 46 has a recess therein which is shaped to receive one of the wings 51. Therefore, one of the wings 51 on each lock 45 extends upwardly and is received in the recess in the rubber 46 above the lock, and the other wing 51 extends downwardly and is received in the recess in the rubber 46 below the lock. When the respective wings 51 are received in the recesses in the rubbers 46, a part 53 of each rubber extends around the wings so that each rubber part 53 provides a physical separation between the wing 51 of the lock and the inside edge of the casing 41.

Each lock 45 also has a locking tab 52. The locking tabs 52 are able to extend outwardly through apertures 54 to protrude proud from the main casing 41 of the locking device. The tabs can also be retracted back through the apertures 54 into a retracted position as shown in FIG. 5. The lock tabs 52 (and indeed the locks 45) are biased towards the retracted position of FIG. 5 by the pressure exerted on the lock wings 51 by the rubber parts 53. Consequently, when the locking device is operated to extend the locking tabs 52, the rubber parts 53 become compressed between the lock wings 51 and the inside of the casing 41. The side edge of the casing 41 is provided with a series of additional apertures 55. When the locks 45 are moved into the extended position, the rubber parts 53 become compressed and some of each part 53 can squash out into the apertures 55 to allow sufficient movement of the locks. The way in which the locks 45 are extended and retracted is described further below.

The top of the main casing 41 has a round open bore 48 therein. The diameter of the bore 48 is initially wide before stepping down to become a narrow bore 49 of smaller diameter extending further down into the casing. The insert 47 is a cylindrical component with an outside diameter that substantially matches the internal diameter of bore 48. Insert 47 is therefore inserted down into opening 48 so that the base of the insert 47 abuts with the step where wide bore 48 steps down to become the narrow bore 49.

The base of the insert 47 has a threaded hole which aligns with the narrow bore 49 when the insert 47 is inserted. Screw 44 extends into the wide bore 48 and its screw threads allow it to be screwed through the threaded hole in the insert 47. The screw 44 extends down through internal narrow bore 49. The end of the screw 44 that is inside the locking device has a pointed end 50.

When the locks 45 are in the retracted position (as shown in FIG. 5), the pointed end 50 of the screw is received between a pair of small sloped surfaces 56 on each lock 45. Consequently, when the screw 44 is rotated to screw it further into the casing 41, the pointed end 50 engages with the sloping surface 56 on each lock to force the locks apart. This forces the lock tabs 52 to project out through the apertures 54 to protrude proud from the casing 41. Further rotation of the screw 44 in the same direction causes the screw 44 to force its way down between the now separated locks 45 until the pointed end 50 of the screw is received in a correspondingly shaped notch 57 in the casing 41. When the screw 44 is fully screwed in, the flat top face of the screw's bolt head end will be approximately flush with the top end of the lock casing 41. However, the space around the bolt head in the mouth of wide bore 48 allows sockets etc to be inserted to operate the screw nonetheless.

It will be appreciated that rotating the screw 44 in the opposite direction causes the pointed end 50 of the screw to retract out of notch 57, and the screw 44 proceeds to retreat out from between the locks 45 until it again reaches the position of FIG. 5. This then allows the locks 45 to retract back into the casing 41 under the bias provided by rubber parts 53. This is how the lock tabs 52 are retracted.

The way in which the locking mechanism shown in the Figures can be used to secure the tooth 10 to the adapter 20 is as follows.

First, the tooth 10 is positioned on the nose 21 of the adapter so that the apertures 12 in the tooth come into register with the aperture 22 in the adapter as shown in FIGS. 2-3. The holding member 30 is then inserted axially into the registered apertures 11,21. After being inserted, the holding member is moved slightly laterally so that the insides of its shoulders 31 engage with corresponding edges 60 on the adapter nose 21. This engagement prevents the holding member from moving axially back out of the registered apertures. The locking device 40, with the lock tabs 52 initially retracted, is then inserted into the apertures along with the holding member 30 as shown in FIG. 2. Once inserted in this way, the screw 44 can be rotated to extend the locking tabs so that the tabs project into the notches 61, thereby securing locking device 40 in position. It can be seen that the casing 41 of the locking device has an elongate rib 63 which slides into the elongate slot 32 in the holding member when the locking device 40 is inserted into the apertures. This helps to align the locking device 40 with the holding member 30 and to correctly position the locking device within the apertures.

When the holding member 30 and the locking device 40 are inserted and operated as described in the previous paragraph, the tooth 10 is locked to the adapter 20. If it is desired to remove the tooth 10 from the adapter 20, it is merely a matter of operating the screw 44 to retract the locking tabs thereby allowing locking device 40 to be removed. The holding member 30 can then also be removed enabling the tooth 10 to be disconnected from the adapter 20.

It will be clearly appreciated that various other changes and modifications may be made to the embodiment of the invention presently described without departing from the spirit and scope of the invention. The present invention can be used in a variety of different industrial machinery application as described below.

In the ensuing embodiments, like reference numerals shown in the Figures refer to like features previously described.

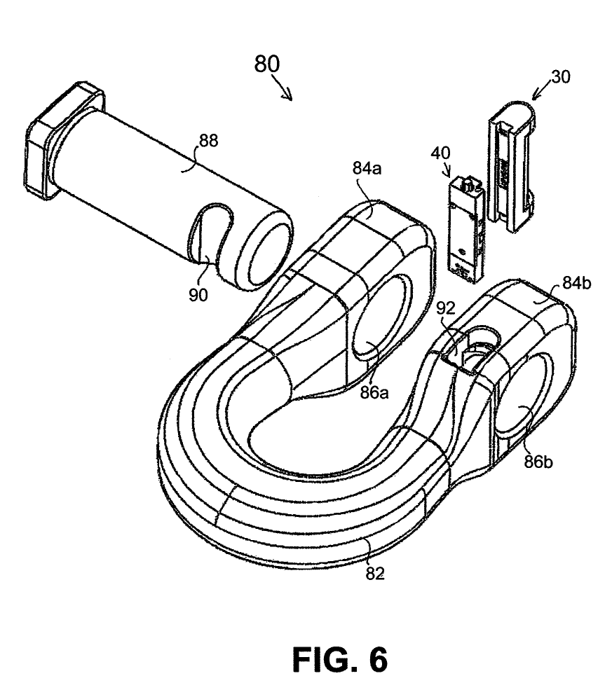

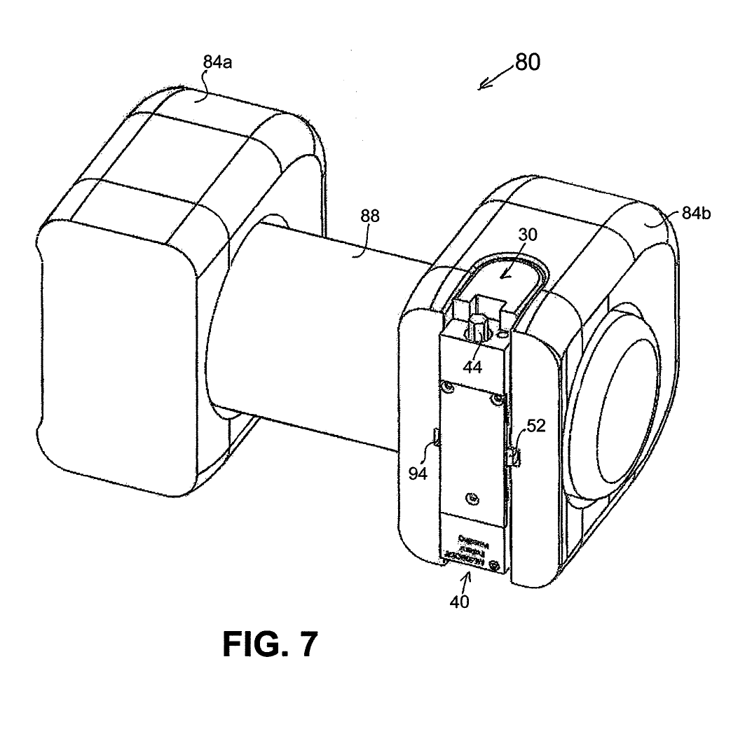

In accordance with another embodiment of the present invention shown in FIGS. 6 and 7, there is provided an industrial shackle assembly 80 including the holding member 30 and the locking device 40. The shackle assembly 80 further includes a U-shaped shackle body 82 defining a pair of arms 84a, 84b, in turn, defining respective spaced apart apertures 86a, 86b. The arm 84b also defines a passage 92 intersecting with aperture 86b and in which the holding member 30 and the locking device 40 can be provided. The shackle assembly 80 further includes a locking pin 88 for inserting into the apertures 86a, 86b, and defining a recess 90 in which the holding member 30 can be locked in place by the locking device 40.

In use, the pin 88 is inserted into the apertures 86a, 86b, and the holding member 30 is positioned in the passage 92 so that it is engaged within the pin recess 90. As can best be seen in FIG. 7, the locking device 40 is then also provided in the passage 92 and the threaded rod 44 is adjusted so that the locking tabs 52 protrude into complementary internal locking recesses 94 of the arm 84b.

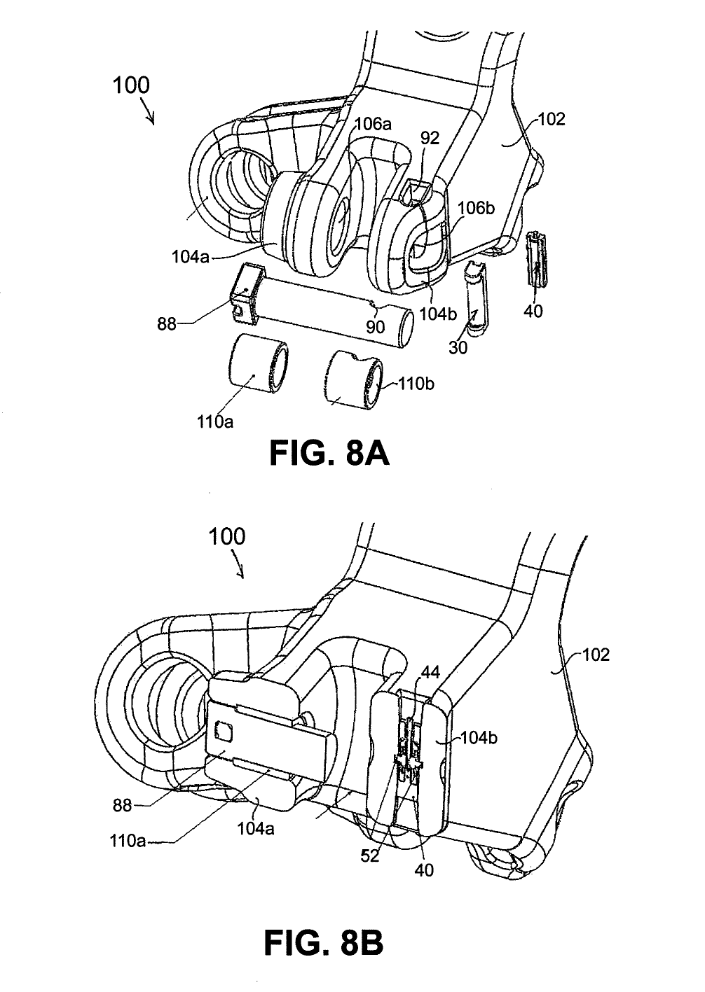

In accordance with another embodiment of the present invention shown in FIG. 8, there is provided an industrial upper hoist assembly 100 including the holding member 30 and the locking device 40. The hoist assembly 100 further includes a hoist body 102 defining a pair of arms 104a, 104b, in turn, defining respective spaced apart apertures 106a, 106b. The arm 104b also defines a passage 92 intersecting with aperture 106b and in which the holding member 30 and the locking device 40 can be provided. The hoist assembly 100 further includes a locking pin 88 for inserting into the apertures 106a, 106b, and defining a recess 90 in which the holding member 30 can be locked in place by the locking device 40. The pin typically rests in a pair of bushes 110a, 110b fitted within respective apertures 106a, 106b.

In use, the pin 88 is inserted into the bushes 110a, 110b within apertures 106a, 106b, and the holding member 30 is positioned in the passage 92 so that it is engaged within the pin recess 90. The locking device 40 is then also provided in the passage 92 and the threaded rod 44 is adjusted so that the locking tabs 52 protrude into complementary internal locking recesses of the arm 104b.

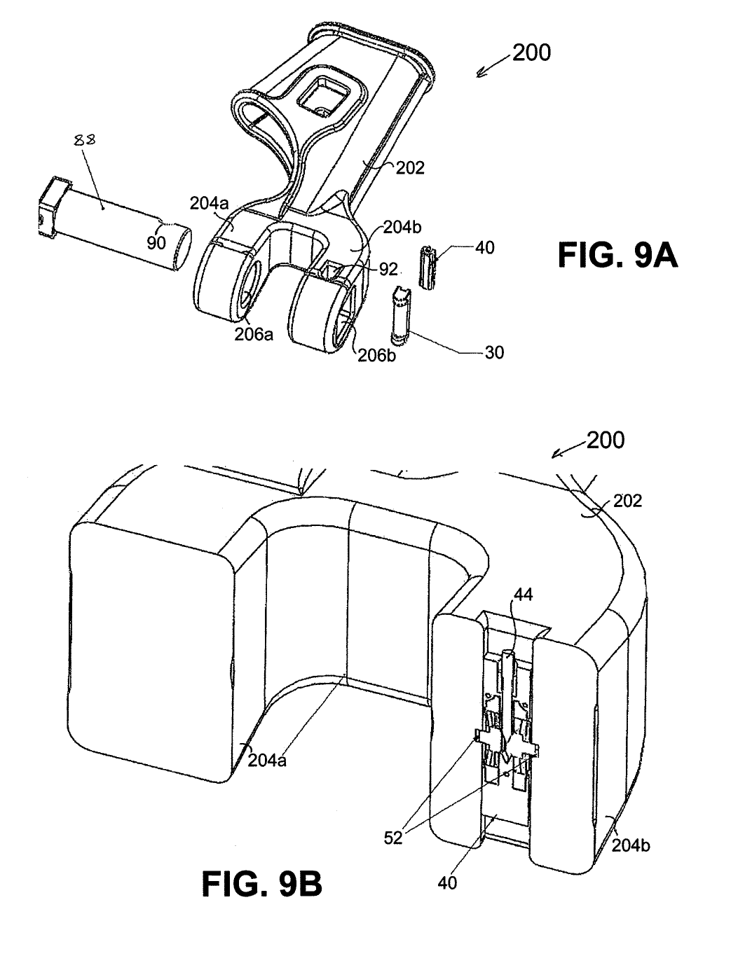

In accordance with another embodiment of the present invention shown in FIG. 9, there is provided an industrial rope socket assembly 200 including the holding member 30 and the locking device 40. The rope socket assembly 200 further includes a rope socket body 202 defining a pair of arms 204a, 204b, in turn, defining respective spaced apart apertures 206a, 206b. The arm 204b also defines a passage 92 intersecting with aperture 206b and in which the holding member 30 and the locking device 40 can be provided. The rope socket assembly 200 further includes a locking pin 88 for inserting into the apertures 206a, 206b, and defining a recess 90 in which the holding member 30 can be locked in place by the locking device 40.

In use, the pin 88 is inserted through the apertures 206a, 206b, and the holding member 30 is positioned in the passage 92 so that it is engaged within the pin recess 90. The locking device 40 is then also provided in the passage 92 and the threaded rod 44 is adjusted so that the locking tabs 52 protrude into complementary internal locking recesses of the arm 204b.

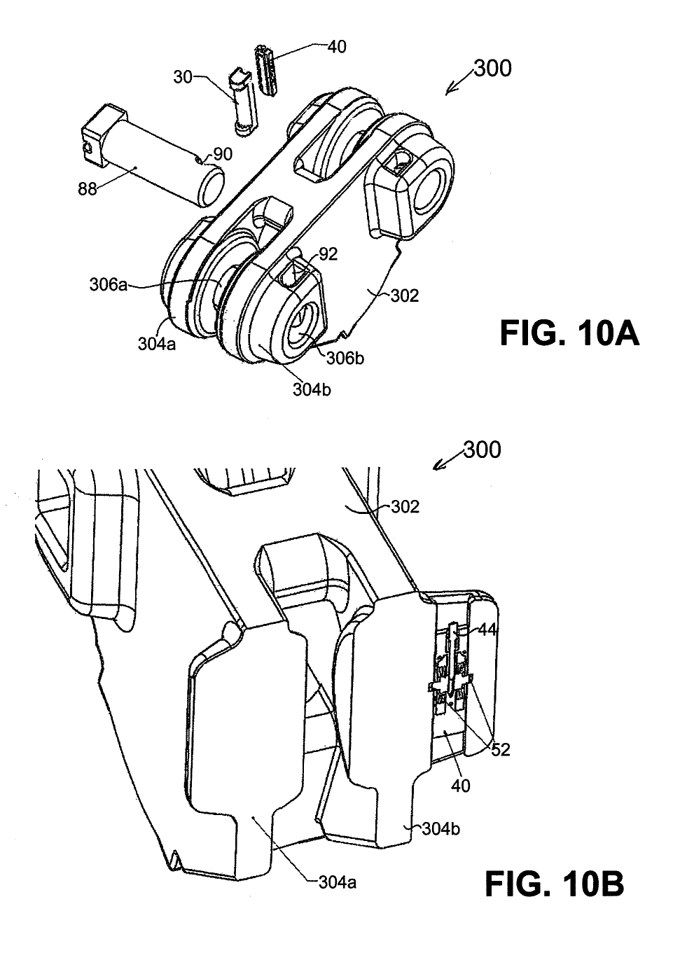

In accordance with another embodiment of the present invention shown in FIG. 10, there is provided an industrial spreader bar assembly 300 including the holding member 30 and the locking device 40. The spreader bar assembly 300 further includes a spreader bar body 302 defining a pair of arms 304a, 304b, in turn, defining respective spaced apart apertures 306a, 306b. The arm 204b also defines a passage 92 intersecting with aperture 306b and in which the holding member 30 and the locking device 40 can be provided. The spreader bar assembly 200 further includes a locking pin 88 for inserting into the apertures 306a, 306b, and defining a recess 90 in which the holding member 30 can be locked in place by the locking device 40.

In use, the pin 88 is inserted through the apertures 306a, 306b, and the holding member 30 is positioned in the passage 92 so that it is engaged within the pin recess 90. The locking device 40 is then also provided in the passage 92 and the threaded rod 44 is adjusted so that the locking tabs 52 protrude into complementary internal locking recesses of the arm 304b.

1. A locking device for use in securing a first part relative to a second part, the locking device having a body, one or more locking portions which can be extended to protrude outwardly relative to the body and also retracted inwardly relative to the body, biasing means for biasing said locking portions to retract into the body, and means for selectively extending and retracting the one or more locking portions.

2. A locking device as claimed in claim 1, wherein the first part or the second part, or both, has/have indent(s), recess(es), notch(es) with which the locking portion(s) can engage to secure the first part relative to the second part.

3. A locking device as claimed in claim 1, wherein the one or more locking portions comprise one or more locking tabs.

4. A locking device as claimed in claim 1, wherein the body comprises a casing for housing internal components of the device, and the body is formed from two or more parts which can be assembled to form the casing.

5. A locking device as claimed in claim 4, wherein the casing has one or more openings to allow components of the device to extend through the casing.

6. A locking device as claimed in claim 5, wherein there are two locking portions, each comprising a locking tab, which can extend out from inside the body through openings in opposing long sides of the body.

7. A locking device as claimed in claim 1, wherein the means for selectively extending and retracting the one or more locking portions comprises a threaded rod mounted in a threaded opening in a part of the body which is accessible even when the device is in place to secure the first part to the second part.

8. A locking device as claimed in claim 7, wherein one end of the rod extends proud of the body at least when the locking portion(s) are retracted, the said end being configured to connect to a tool to be rotated.

9. A locking device as claimed in claim 7 or claim 8, wherein a threaded portion of the rod extends through the threaded opening into the body and is configured such that rotation of the rod in one direction causes the rod to screw into the body, and rotation of the rod in the other direction causes the rod to unscrew and protrude out from the body.

10. A locking device as claimed in claim 9, wherein the one or more locking portions comprise one or more locking tabs, and a portion of the rod that extends into the body engages with one or more of the locking tabs.

11. A locking device as claimed in claim 1, wherein said biasing means pushes against said locking portions in their inward direction of retraction so that the locking portions can be entirely retracted within the body.

12. A locking device as claimed in claim 11, wherein the locking portions are biased by resilient rubber mounts which are located within the body.

13. A locking device as claimed in claim 10, wherein the end of the rod that is inside the body is tapered so as to provide an angled surface that engages the one or more locking tabs forcing the locking tab(s) to extend progressively outwardly relative to the body as the rod is screwed into the body.

14. A locking device as claimed in claim 1 which can be used with a holding member to secure the first part relative to the second part, the holding member being an elongate block-shaped component with a protruding shoulder on each end.

15. A locking device as claimed in claim 14, wherein alignment means are provided to help align the locking device with the holding member.

16. A locking device as claimed in claim 15, wherein the first part is a locking pin defining a recess in which the holding member can be received.

17. A locking device as claimed in claim 16, wherein the second part is a body defining spaced apart apertures for receiving the locking pin, the body forming part of a shackle, hoist rope socket, spreader bar or other like industrial parts assembly.

18. A locking device as claimed in claim 1, wherein the first part is an excavator tooth point member and the second part is an adapter.

19. A mechanism for securing a first part relative to a second part, the mechanism comprising a holding member for engaging with a locking device, the holding member having at least one protruding or recessed portion which can engage with a recessed or protruding portion in one or both of the first part or the second part, and the locking device having a body, one or more locking portions which can be extended to protrude outwardly relative to the body and also retracted inwardly relative to the body, biasing means for biasing said locking portions to retract into the body and means for selectively extending and retracting the one or more locking portions.

20. A method for securing a first part relative to a second part, the method involving:
assembling the first part and the second part together such that an aperture in the first part becomes registered with a corresponding aperture in the second part,
inserting a holding member into the registered apertures such that at least one protruding or recessed portion of the holding member engages with a recessed or protruding portion in one or both of the first part or the second part to prevent removal of the holding member from the apertures and
inserting a locking device into the apertures and then operating the locking device such that one or more locking portions act against biasing means and extend to engage with one or both of the second part or the first past to prevent removal of the locking device from the apertures.
